(19) United States
(12) Patent Application Publication
(10) Pub. No.: US 2006/0136308 A1
(43) Pub. Date: Jun. 22, 2006

(54) Method and process for consolidated marketing and fulfillment portals for specialized vertical industries

(76) Inventor: Mike Ratchford, Houston, TX (US)

Correspondence Address: BUSKOP LAW GROUP, P.C., 1776 YORKTOWN, SUITE 550, HOUSTON, TX, 77056, US

(21) Appl. No.: 11/303,141

(22) Filed: Dec. 16, 2005

Related U.S. Application Data
(60) Provisional application No. 60/636,836, filed on Dec. 16, 2004.

(51) Int. Cl. G06Q 30/00

(52) U.S. Cl. 705/26

(57) ABSTRACT

Methods and electronic commerce portals for consolidated marketing and fulfillment for vertical specialized industries enable a company to design a website, which allows a company to control what its agents are purchasing as supplies for their job. The electronic commerce portal can comprise a retail marketing website, a private corporate intranet website, or an industry partner website. The re-skinnable portal can display a modifiable collection of products and services. The re-skinnable portal can include an e-commerce store connected to a network. The e-commerce store can include a database which further includes a stationary section, a marketing section, a business development section, a lead generation section, a promotional products section, a remarketing section and a sales training material section. The methods and electronic commerce portal enables a client to purchase customized goods and services.

### CROSS REFERENCE TO RELATED APPLICATIONS

The present application claims priority to co-pending U.S. Provisional Patent Application Ser. No. 60/636,836 filed on Dec. 16, 2004.

### FIELD

The embodiments relate to methods and processes for consolidated marketing and fulfillment portals for specialized vertical industries.

### BACKGROUND

More and more Internet users are realizing the ease and convenience of buying and selling online. As a result, collectors, hobbyists, small dealers, unique item seekers, bargain hunters, and other consumers, are able to buy and sell millions of items at various online shopping sites.

Businesses and corporations also look to the Internet to purchase supplies or other goods for their businesses. For instance, many companies buy office supplies and printing materials from suppliers who have electronic commerce (e-commerce) sites. These companies often look to their ecommerce suppliers for business cards, brochures, marketing materials and the like. While the convenience and other benefits of online shopping cannot be overstated, there still exists limitations to this type of commerce.

For instance, existing electronic commerce websites are generally incapable of identifying a user and automatically providing information specific to the user. Thus, the host limits information provided on the site to that which can be made generally available to all authorized users. This limits flexibility in customizing the types of information presented to different categories of users.

The vertical industries are particularly affected by these issues. Employees who work in the these industries often need products to increase their productivity. These employees often use business cards, brochures, pamphlets and many other marketing devices in order to increase sales. However, because of the corporate structure, obtaining these supplies can be time consuming and arduous. From the employers perspective, employees cannot be given blanket authority to order and purchase products without first having the logos, information, items and the like approved first. The approval of these items is critical for brand control. Consequently, a need exists for an e-commerce portal, for example, a website, that would enable employees to get the products they need while not having to get every purchase order approved by upper management. A need further exists for that e-commerce portal to be customizable with the employer's limitations on purchases, product availability and product design implemented into the website.

Unfortunately, many business, particularly small businesses, do not have the money or resources to produce such a website. A website includes a collection of web pages in an Internet programming language such as HTML (hypertext markup language), ASP or XML. Each page includes content, such as text, graphics, or other multimedia material. The page may also include links and buttons (e.g., “Submit”). Creating a web site requires generating a plurality of pages using one or more of these programming languages. Adding content to a web site once created or modifying the web site also involves using one or more of these programming languages. This makes it difficult for individuals without specific programming knowledge to create a web site or to create content for or modify an existing web site.

Another difficulty encountered in website creation and subsequent modification arises from the fact that often several individuals are involved in creating and authorizing the Web pages. Often, the format and content of Web pages involves the collaboration of many individuals. For example, one or more persons may propose the text for a page, another may be responsible for graphics, another may add appropriate legal notices (e.g., trademark or copyright notices), etc. In such cases, coordinating the collaborative effort may be difficult and if done manually can cause delays. A manual approach also makes it difficult to adequately track development, or ensure that all contributions are timely and properly integrated in the Web site. Similar problems are posed in connection with ensuring that all requisite approvals are obtained by authorized content approvers prior to posting the final version of the content to the website.

The success of an online shopping site depends upon its ability to provide an enjoyable shopping experience and an easy-to-use environment in which buyers and sellers can conduct business efficiently. Current online shopping sites have certain limitations in the manner in which they present information to users.

A need exists for a secure e-commerce portal, or website, in which a company's employees can purchase the supplies and goods they need to be successful while the employers can control the types of products available, the types of logo designs, and the amount of purchases.

A need exists for a cost efficient way to develop such an e-commerce portal, so that business of all sizes and budgets can reap the benefits of e-commerce.

The embodiments fulfill those needs.

### BRIEF DESCRIPTION OF THE DRAWINGS

In the detailed description of the embodiments presented below, reference is made to the accompanying drawings, in which:

FIG. 1 depicts an embodiment of order processing at a fulfillment center.

FIG. 2 depicts an embodiment of the development of an electronic commerce portal.

FIG. 3 depicts an illustration of a computer system to perform the embodiments.

The present embodiments are detailed below with reference to the listed Figures.

### DETAILED DESCRIPTION OF THE PREFERRED EMBODIMENTS

Before explaining the present embodiments in detail, it is to be understood that the embodiments are not limited to the particular embodiments herein and can be practiced or carried out in various ways.

The embodiments relate to novel technology for consolidated marketing and fulfillment for specialized vertical industries such as the finance industry. The embodiments can be used for the real estate industry, insurance, travel, and any commercial business that has multiple business locations and individual agents throughout the world. The embodiments can be utilized so that the marketing is sourced to marketing partners and then merged into website portals for sales and commissions.

The embodiments can include methods and electronic commerce portals for specific organizations and industries, and then licensing the proprietary methods and portals for use on websites.

The embodiments enable a company or organization to ensure consistent quality, consistent branding, and content control when its agents purchase printed products for use in the field. The embodiments eliminate the risk of non-compliance with the company's or organizations' standards for such products.

The embodiments do not require a purchaser to buy additional equipment or software or to incur costs associated with increased staff time or additional equipment/personnel.

The embodiments facilitate the integration of the selection, ordering, customization, fulfillment and delivery of commercial printing and marketing/promotional products. The embodiments can be used for the design, customization, execution and delivery of commercial printing, both for one to four color offset printing and digital printing, for a full line of products including stationery, sales flyers, postcards, brochures, and presentation folders.

The embodiments can be used for customizable card products for marketing or client development, such as imprinting and customization of a variety of promotional items, including awards, wearables, various other imprinted articles, a limited selection of office supplies, balloon boxes and a wide variety of client after sale items used as sales tools. The embodied methods and portals can be used for development and execution of programs specifically tailored for specialized industries and purposes, development of customized market building programs for clients, and fulfillment services and delivery/mailing services.

The embodiments can provide industry specific business knowledge for product and printing needs. The selection of products and services can be more tailored, more effective, more affordable, and more accessible than normally available through multiple catalogues and providers.

The embodiments can entail using a catalogue via the internet rather than using direct mail. The use of the internet significantly reduces overhead and pass-through costs, adds a wider reach, and allows 24/7 availability of the services. The embodiments allow for products and services that are fully scalable, allowing businesses to order only what they need, exactly when they need it.

An embodiment of the portals can be a re-skinnable, or re-configurable, electronic commerce portal for commerce over a network. A skin can refer to the visual attributes of a website, electronic commerce portal, or e-commerce store. Re-skinnable can refer to the ability of a particular website, electronic commerce portal, or e-commerce store to be re-configured easily or re-designed regarding the visual attributes so that the appearance is modifiable.

The portal can include a retail marketing website, a private corporate intranet website or an industry partner website. The re-skinnable portal can display a modifiable collection of products and services.

The electronic commerce portal can include an on-demand fulfillment center connected to the e-commerce store. The on-demand fulfillment center can fulfill orders placed to the e-commerce store, and deliver orders from the e-commerce store to vendors contracted to the fulfillment center.

The client can customize and order printing of a large or small quantity of customized signs and flyers from the fulfillment center.

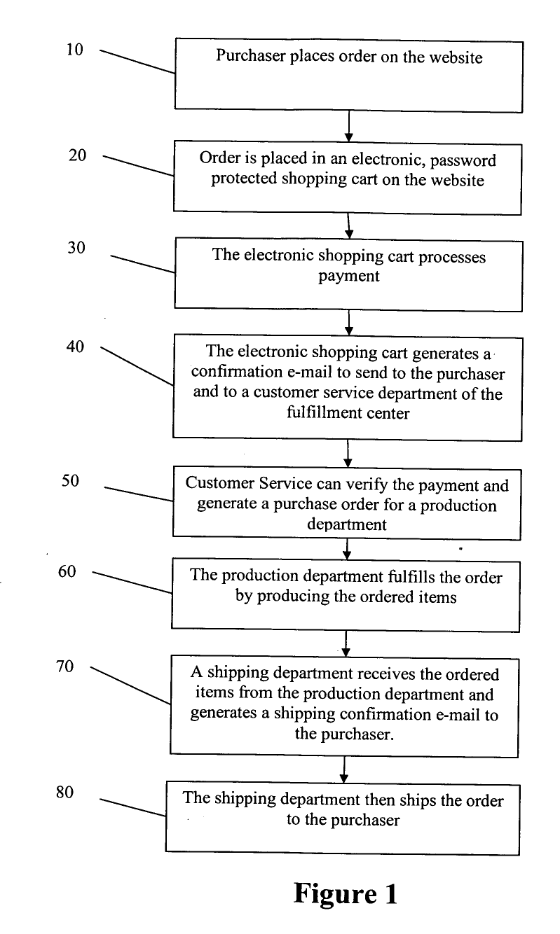

In reference to the figures, FIG. 1 depicts the order fulfillment process. First, a purchaser places an order on the website, or e-commerce store (10). The order can then go to an electronic password protected shopping cart integrated into the website (20). Payment can be made with a credit card or other authorized company charge method over a secure network. The electronic password protected shopping cart then process the payment information (30). An order confirmation can then be sent to the purchaser and to a customer service department via e-mail (40). Customer service can verify the payment and then generate a purchase order, or work order, for a production department (50). The production department can then fulfill the order by printing, folding, producing, and/ or developing the products or programs (60). A shipping department can receive the ordered items from the production department and can then generate a shipping confirmation e-mail to be sent to the purchaser (70). The shipping department can then ship the ordered items to the purchaser (80). Imprinted items can be shipped in between five to seven days from the fulfillment center. Items in stock are shipped the same day or the next day.

The embodied portals can include a fully customizable website, or e-commerce store. For example, a company can have many agents. These agents work under the name of the company. The agents need business cards, brochures, marketing materials and the like with the company's logo, but the individual's specific name and contact information. The present embodiments enable the company to set up a customized website, or e-commerce store, in which its agents can order the necessary supplies directly from the supplier. The customized website can include specific categories of products, which can be chosen by the company, and within each category, a litany of products can be included, which can also be chosen by the company.

The e-commerce portals can include forums and discussion boards so that agents or purchasers can discuss the latest relevant topics in their industry.

The e-commerce store can be accessible from a purchaser's computer continuously, seven days a week and twenty-four hours a day.

The e-commerce store can include a security protocol for restricted access. The e-commerce store can include customizable portal rules that automatically determine the arrangement of the display of vendors linked to the portal.

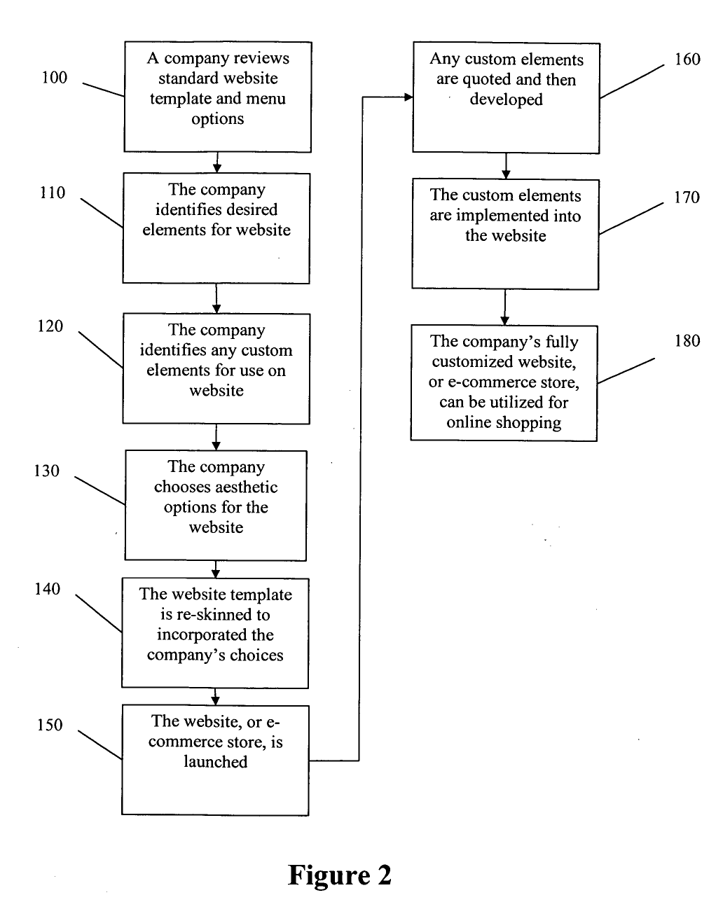

FIG. 2 depicts the method of developing the customized e-commerce portal. First, a company can review the standard website template and menu options (100). The company can then identify all desired elements to be put on their version of the website (110). For example, the company can choose the categories of products to be included on the website. These categories of products can be various e-commerce store sections. As an example, the e-commerce store sections are akin to aisles in a grocery store; therefore, the e-commerce store sections can be virtual aisles of the e-commerce store. The company can identify any custom elements to be incorporated on the website (120). The aesthetic features of the website can be chosen by the company (130). The aesthetic features include color, font, placement of advertisements and links, placement and design of the company logo, and other such considerations can be decided upon. The website template can then be re-skinned to incorporate all of the choices made by the company (140). The re-skinnable portal is re-skinnable within a short period of time to reflect an integrated company image. The website, or e-commerce store, can then be launched (150). Any custom elements desired by the company can then be quoted and developed (160). The custom elements can then be implemented into site (170). The fully customized e-commerce store for the company can then be utilized for the company's purchasing needs (1 80).

The chosen e-commerce store sections, or categories of products, can be re-skinned simultaneously. The simultaneous re-skinning can occur over a time period of less than 48 hours if the company chooses standard website options. The e-commerce portal can be re-skinnable for non-commercial users as well. The non-commercial users can be church organizations, community organizations and political interest groups.

The website can include at least one strategic partner hyperlinked to at least one section of the e-commerce store. For example, if the website is customized for a real estate company, the website can include a hyperlink to a strategic industry partner such as a credit counseling company or a mortgage company.

An example of a category of product, or section of the e-commerce store, that the company can include on their website is a stationary section. The stationary section can facilitate ordering customized imprinting and payment for business cards, letterheads, envelopes, notepads, “Thank you” cards, and the like. The customers can purchase business cards, letterheads, envelopes and other like materials already with their company's name and logo on them. The company has already chosen what particular products are approved by choosing those products for availability on the website, or e-commerce store.

The company can choose to include a marketing materials section for their e-commerce store. The marketing materials section can facilitate ordering customized imprinting and payment for products such as brochures, flyers, folders, door hangers, booklets, flyers, and the like.

A business development section can be available for incorporating into the website. The business development section can facilitate ordering and payment of products such as best leads programs, yard signs, referral generating balloon boxes, referral multiplier programs, refinance referral generators, letter magnets, newsletters, “Thank you for your purchase” cards, anniversary cards, holiday cards, birthday cards, brochures, postcards and the like.

The referral generating balloon box can include a number of custom printed cards attached to a helium balloon inserted in a box that communicate the reason for sending the box. The balloons can be eighteen inch (18″) Mylar printable balloons adapted to hold helium for a minimum of between 48 hours to 72 hours.

The best leads program can provide the purchaser with customized generation of between one and twenty customized pieces offered as a package and then mailed in sequence over a defined period of time, in order to maintain contact with past clients.

Another example of a category of product that can be available for the e-commerce store can be a lead generation section. The lead generation section can facilitate custom design and production of prospect-lead generating products and programs like HomeBuyer CDs, yard signs, direct mail pieces, e-mail requests for telemarketing leads, and specialty products for giving away for lead generation and client retention. Lead generating products can include specialty niche marketing programs which can be print pieces and promotional gift items, lead generating door hangers, and lead generating magnets. The customized signs can be pre-design stock items or personalized items, and can include three different staking options. Specific sign sizes can be created as well. A brochure box can be ordered and affixed to the signs. Customized home flyers can be ordered for the brochure box.

Products such as targeted direct mail, internet leads, telemarketing leads, door hangers, and the like can be lead generation tools as well. The products in the lead generation section can include a targeted mail program or any other proven and tested marketing program that produces prospects and leads on a consistent basis. The typical targeted mail program includes at least a letter or postcard with a message that is industry specific. A specified personalized message printed on the carrier is delivered to a list of target names and addresses or to the client or client directed facility.

A remarketing leads section can be chosen for the e-commerce store. The remarketing leads section can facilitate ordering and payment of customized design and production for a marketing strategy to re-contact prospects and clients. The remarketing leads section can include post-client programs, such as predetermined materials and prepackaged sets of mailing directed to past clients by the fulfillment center or any other customized communications. E-mail blasts and automatic responders can be included in the remarketing leads section.

For example, a typical program can be based upon contacting past clients a specific number of times per year. The program has been proven to enable the user to maintain repeat business and generate future referrals. The program can generate a full recovery of annual cost with the first mailing to previous and existing clients. A client specific program can include post-closing “Thank You” cards, anniversary cards, “Client” newsletters, “Touch Base” postcards, holiday cards, and cash flow models or any other marketing piece or method to keep the clients' name in front of past clients.

The company can choose a sales training material section. The sales training material section includes programs and products to help teach sales techniques to the agent or employee of the company. The sales training material section can include coaching programs, training on using marketing products, and training on using business development products. The various programs can be delivered as a streaming or downloadable audio or video file, subscriptions to the same, or white paper reports. For example, the book “How to Sell to an Idiot” by John Hoover and Bill Sparkman can be included as a product in the sales training material section. Sales training seminars can be included in the section as well.

The company can choose to include a promotional products section for the e-commerce store. The promotional products section can provide the ability to order small or large sets of personalized branded gifts that can be used by interest parties for various purposes. The promotional products section can facilitate custom design and production of selected products to retain or develop business. Examples of on-demand products are golf balls, towels, engraved pens, flashlights, calculators, mugs, mouse pads and the like. These promotional products can be available on the e-commerce store and produced on demand. For example, agents of the company with the e-commerce store can purchase golf balls with the company's logo and the agent's contact information. These golf balls can then be distributed at a golf tournament. Of course, the promotional products are not limited to golf balls, but rather could be any kind of product that can be printed on or engraved.

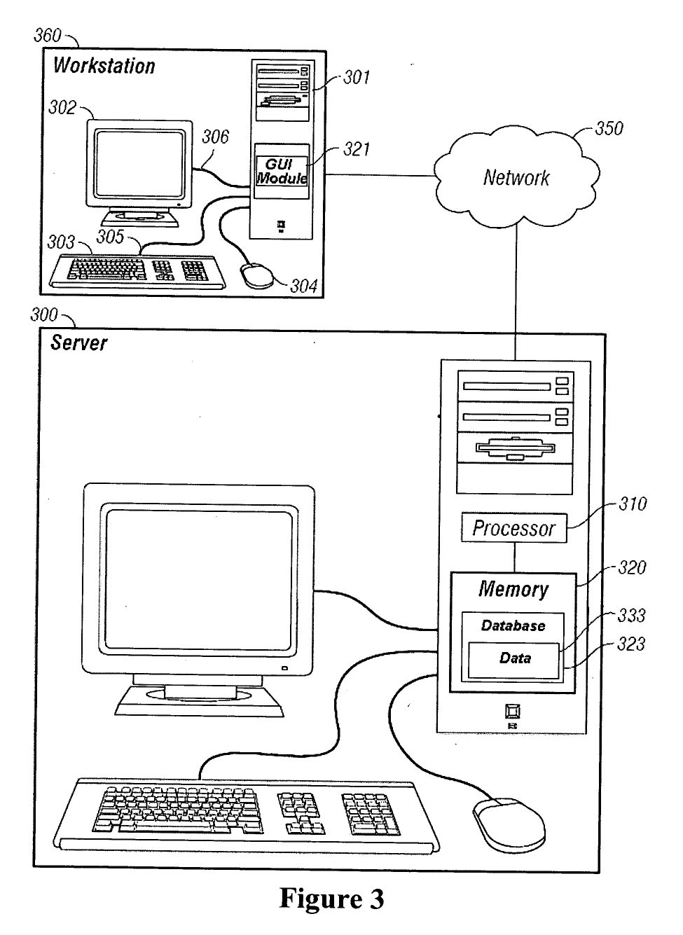

With reference to the figures, FIG. 3 depicts an illustration of a computer system to perform the embodied methods. The re-skinnable electronic commerce portal can include an e-commerce store connected to a network (350) which is accessible via at least one graphical user interface (GUI) on a workstation (360). The workstation (360) is coupled to a server (300) via a network (350). The workstation includes a workstation computer (301), which can be coupled to a video display (302) via an external graphics bus (306). The external graphics bus (306) can be an Advanced Graphics Port (AGP) compliant bus. The term “coupled” encompasses a direct connection, an indirect connection, or the like. Server (300) in one embodiment includes a processor (310), such as the Pentium™ III processor manufactured by Intel Corp. of Santa Clara, Calif. In another embodiment, the processor (310) can be an Application Specific Integrated Circuit (ASIC). Server (300) can include a memory (320) coupled to the processor (310). Memory (320) encompasses devices adapted to store digital information, such as Dynamic Random Access Memory (DRAM), Rambus™ DRAM (RDRAM), flash memory, a hard disk, an optical digital storage device, a combination thereof, etc. The workstation computer (301) can be coupled to a keyboard (303) and a mouse (304) via an external computer bus (305). In one embodiment, the external computer bus (305) is a Universal Serial Bus (USB) compliant bus. In one embodiment, the workstation computer (301) can include a graphical user interface (GUI) module (321) to implement a graphical user interface.

Memory (320) can include instructions adapted to be executed by the processor (310) to perform a method in accordance with a present embodiment. The term “instructions adapted to be executed” is meant to encompass any instructions that are ready to be executed in their present form (for example, machine code) by a processor, or require further manipulation (for example, compilation, decryption, decoding, or provided with an access code, etc.) to be ready to be executed by a processor (for example, processor (310)).

Examples of network (350) include the internet, a WAN (wide area network), LAN (local area network), an intranet, a communications network, a computer network, a combination thereof, etc. In one embodiment, the server (300) is coupled to a storage device that can store data on a magnetic medium such as a magnetic disk. For example, the storage device may store application programs and associated data files/documents. Examples of documents include word processing documents, spreadsheet documents, HTML (Hypertext Markup Language) documents, and the like. Workstation (360) can access data stored in the storage device via server (300) and network (350). In an embodiment, workstation (360) can display information on display (302) by receiving information signals to server (300) via network (350). Examples of display information include data a GUI component, a web page, and the like.

The e-commerce store can include a database (323) resident in memory (320) on a server (300) having a processor (310). The database (323) can include data (333), which can encompass hierarchical data, non-hierarchical data, and the like. Data (333) can be a document corresponding to a particular application such as a word processing document, a spreadsheet document, an HTML document, and the like. The data (333) can include information regarding products and services for the e-commerce store. For example, data (333) can include information on products and services for at least three members of the group consisting of a stationary section, a marketing section, a business development section, a lead generation section, a promotional products section, a remarketing leads section, and/or a sales training material section. The data can include information on the products and services of at least three of the above mentioned sections.

An embodiment of a method for consolidated marketing for the specialized vertical industries can entail enabling a client to create and print customized program letters and cards at a client's facility. The customized cards can be for one or more borrowers. For example, in the finance industry, the borrowers can be either pre-approved to purchase goods or services up to a pre-defined amount or be denied and/or placed in provisional status.

An embodiment of a method can allow the client to print customized letters that describe the use, the features, and the benefits of the customized cards at their own facility. The customized letters include the issued card described in the letter on the same pre-printed carrier.

For the finance industry, customized cards can include information ranging from the borrower's name to an amount of the borrower's loan to a broker's name and combinations thereof. The broker can be a real estate broker, a mortgage broker, a bank, a credit union, other mortgage lenders and combinations thereof. For other industries, the card information and the letter can be completely re-conformed and designed to match industry standards.

The client can customize and order printing of a large or small quantity of customized signs and flyers from the fulfillment center.

The client can customize and order large or small quantities of marketing materials, such as business stationery, business envelopes, business brochures, door hangers, other marketing materials, and any combinations thereof. The customized signs, flyers, and marketing materials can be shipped directly to the client. Imprinted items can be shipped in between five to seven days from the fulfillment center. Items in stock can be shipped the same day or the next day.

The customized signs can be pre-design stock items or personalized items and can include three different staking options. Specific sign sizes can be created as well. A brochure box can be ordered and affixed to the signs. Customized home flyers can be ordered for the brochure box.

An embodiment of the methods can allow the client to send balloon boxes to any specific location. The balloon box can include one or more balloons and one or more attached customized cards that communicate the reason for sending the box. The balloons can be eighteen inch (18″) Mylar printable balloons adapted to hold helium for a minimum of between 48 hours to 72 hours.

An embodiment of the methods can include the ability to order small or large sets of personalized branded gifts that can be used by interested parties for various purposes.

An embodiment of the methods can deploy a targeted mail program or any other proven and tested marketing program that produces prospects and leads on a consistent basis. The typical targeted mail program includes at least a letter or postcard with a message that is industry specific. A specified personalized message printed on the carrier can be delivered to a list of target names and addresses or to the client or client directed facility.

An embodiment of the methods can include post-client programs, such as predetermined materials and prepackaged sets of mailing directed to past clients by the fulfillment center or any other customized communications.

For example, a typical program is based upon contacting past clients a specific number of times per year. The program has been proven to enable the user to maintain repeat business and generate future referrals. The program can generate a full recovery of annual cost with the first mailing to previous and existing clients. A client specific program can include post-closing “Thank you” cards, anniversary cards, “Client” newsletters, “Touch Base” postcards, holiday cards, and cash flow models or any other marketing piece or method to keep the clients' name in front of past clients.

An embodiment of the methods can provide industry specific business knowledge for product and printing needs. The selection of products and services is more tailored, more effective, more affordable, and more accessible than normally available through multiple catalogues and providers.

An embodiment of the methods can entail creating private portals for specific organizations and industries, then licensing the proprietary method for use on websites.

While these embodiments have been described with emphasis on the preferred embodiments, it should be understood that within the scope of the appended claims the embodiments might be practiced other than as specifically described herein.

What is claimed is:

1. A re-skinnable electronic commerce portal for business commerce for displaying a modifiable collection of products and services over a network, wherein the re-skinnable portal comprises:
a. an e-commerce store accessible over the network accessible via at least one graphical user interface, wherein the e-commerce store comprises a database resident in memory on a server having a processor, and wherein the database comprises data on products and services for at least three members of the group consisting of:
i. a stationary section;
ii. a marketing materials section;
iii. a business development section;
iv. a lead generation section;
v. a promotional products section;
vi. a remarketing leads section; and
vii. a sales training material section;
b. an on-demand fulfillment center connected to the e-commerce store to perform fulfilling orders placed to the e-commerce store or delivering orders from the e-commerce store to vendors contracted to the fulfillment center, and wherein the re-skinnable electronic commerce portal is re-skinnable within a short period of time to reflect an integrated company image.

2. The re-skinnable electronic commerce portal of claim 1, wherein at least one strategic partner is hyperlinked to data on products and services.

3. The re-skinnable electronic commerce portal of claim 1, further comprising continuous access through a graphical user interface.

4. The re-skinnable electronic commerce portal of claim 3, further comprising a security protocol for restricted access.

5. The re-skinnable electronic commerce portal of claim 1, wherein the stationary section facilitates ordering customized imprinting, and payment of a member of the group consisting of: a business card, a letterhead, an envelope, a notepad, a “Thank you” card, other similar items, and combinations thereof.

6. The re-skinnable electronic commerce portal of claim 1, wherein the marketing materials section facilitates ordering customized imprinting and payment of a member of the group consisting of a brochure, a flyers, a folder, a door hanger, a booklet, other similar items, and combinations thereof.

7. The re-skinnable electronic commerce portal of claim 1, wherein the business development section facilitates ordering customized imprinting and payment of a member of the group consisting of: a best leads program, a referral generating balloon box, a referral multiplier program, a refinance referral generator, a letter magnet, a newsletter, a “Thank you for your purchase” card, an anniversary card, a holiday card, a birthday card, and combinations thereof.

8. The re-skinnable electronic commerce portal of claim 7, wherein the referral generating balloon box comprises a plurality of custom printed cards attached to a helium filled balloon inserted in a box and is shipped to a client specified location.

9. The re-skinnable electronic commerce portal of claim 1, wherein the lead generation section facilitates custom design and production of a member of the group consisting of a yard sign, a direct mail piece, an email request for internet lead, a customized mail piece, an email request for telemarketing leads, a specialty product for giving away for lead generation and client retention, a lead generating balloon box, a specialty niche marketing program comprising a member of the group consisting of: a print piece, a promotional gift item, a lead generating door hanger, a lead generating magnet, and combinations thereof.

10. The re-skinnable electronic commerce portal of claim 1, wherein the promotional products section facilitates custom design and production of selected product to retain or develop business.

11. The re-skinnable electronic commerce portal of claim 1, wherein the remarketing leads section facilitates customized design and production of a marketing strategy to recontact prospects and clients.

12. The re-skinnable electronic commerce portal of claim 1, wherein the sales training material section comprises a member of the group consisting of: a training program, a coaching program, a training program on using marketing products, a training program on using business development products, and combinations thereof.

13. The re-skinnable electronic commerce portal of claim 1, wherein the re-skinnable electronic commerce portal is re-skinned for non-commercial users.

14. The re-skinnable electronic commerce portal of claim 13, wherein the non-commercial users are selected from the group consisting of: church, community, political interest groups, and combinations thereof.

15. The re-skinnable electronic commerce portal of claim 1, wherein the e-commerce store further comprises on-line forums and discussion boards.

16. A re-skinnable electronic commerce portal comprises:
a. an e-commerce store accessible over a network, wherein the e-commerce store comprises a database resident in memory on a server having a processor, and wherein the database comprises virtual aisles; and
b. an on-demand fulfillment center connected to the e-commerce store to perform portal actions, wherein the re-skinnable electronic commerce portal is re-skinnable within a short period of time to reflect an integrated company image.

17. The re-skinnable electronic commerce portal of claim 17, wherein the portal actions comprises fulfilling an order placed to the e-commerce store or delivering orders from the e-commerce store to vendors contracted to the fulfillment center.
